(19) United States
(12) Patent Application Publication
(10) Pub. No.: US 2018/0310763 A1
(43) Pub. Date: Nov. 1, 2018

(54) Temperature Homogenization And Protection Structure Of Barbecue Grill

(71) Applicant: GRAND HALL ENTERPRISE CO., LTD., Taipei (TW)

(72) Inventor: WILLIAM HOME, Taipei (TW)

(21) Appl. No.: 15/499,915

(22) Filed: Apr. 28, 2017

(51) Int. Cl. A47J 37/07

(52) U.S. Cl. CPC A47J 37/0713

(57) ABSTRACT

Disclosed is a temperature homogenization and protection structure of a barbecue grill, including at least one burner and at least one grate. The burner is arranged in the barbecue grill and is provided, on a top side thereof, with a protector board. The protector board includes a plurality of through openings. The grate is arranged in a top opening of the barbecue grill and the grate includes a plurality of ribs. The ribs are provided with at least one temperature homogenization protection section and at least one temperature homogenization sections. The temperature homogenization protection section corresponds in position to the burner and the protector board.

### (a) TECHNICAL FIELD OF THE INVENTION

The present invention relates generally to a temperature homogenization and protection structure in the technology field of barbecue grills and roasters, and more particularly to a structure in which a grate is provided with a temperature homogenization protection zone and a temperature homogenization zone and a burner is provided with a protector board arranged above the burner so that the structure, as a whole, helps homogenize a grilling temperature and also prevents grease/fat, juice, and sauce from dropping from grilled food onto the burner.

### (b) DESCRIPTION OF THE PRIOR ART

Grilling and roasting are a common activity of modern people for they provided food cooked with different styles for people to enjoy and also serve as a social process of enhancing friendship and social communication.

Grilling or roasting is often conducted with a grill. The way, as well as a grate structure, that a conventional barbecue grill takes to grill or barbecue food is such that a grate is placed on an opening formed in a top of the grill and charcoal is filled in the grill for burning and flaming or a burner (such as infrared heater) is used. Food is placed on the grate for heating and cooking. The charcoal flaming or burner used in the conventional grill is arranged to directly face and irradiate thermal energy toward the grate in order to heat and cook food. The charcoal flaming or burner is set to directly face openings or slots of the grate that is placed above the flaming or burner so that a large amount of liquid of grilled food, such as sauce or grease/fat or juice of meat that is being grilled, may directly fall, in a vertical direction, onto the charcoal flaming or the burner during the grilling process. This leads to a large amount of thick smoke, which affects air quality and contaminate the food, and is also harmful to human bodies.

Further, it is also available for burners used as a heat source in a barbecue grill to cook food that a barbecue grid is placed on the opening formed in a top of the barbecue grill and a protection hood is provided inside the barbecue grill at a location above the burner. During grilling food, the protection hood provides shielding such that grease/fat of food, juice of meat, and sauce, will fall onto the protection hood and are prevented from dropping onto the burner to cause situations, such as catching a fire or inducing acidic/basic corrosion. However, such a known structure of barbecue grill suffers at least the following shortcomings:

(1) Due to the slots or opening formed between ribs or bars of the barbecue grate, the transmission and distribution of heating barbecue temperature is generally not uniform and is not homogenized such that food cannot be uniformly and evenly heated and cooked, affecting the taste and flavor of food so grilled.

(2) Although a protection hood is provided above the burners, since the conventional protection hood is generally provided with no openings, radiation heat that emits and irradiates from the upper side of the burner cannot be directly applied to the barbecue grate so that waste of thermal energy results and manufacturing cost of the grill is increased.

(3) Although the protection hood is provided to prevent liquids, such as grease/fat of food, juice of meat, and sauce, from directly dropping onto the burner, the protection hood itself is also heated by the radiation energy of the burner during a process of grilling food such that the liquids of food grease/fat, meat juice, and sauce that drop onto the protection hood also catch a fire on the protection hood and similarly generate a large amount of smoke.

Thus, the conventional structure of barbecue grill, as discussed above, when used for barbecuing or roasting or grilling food with a barbecue grill, does not achieve an effect of temperature homogenization and protection and does not provide an efficacy of true smoke-free grilling As such, further improvement is necessary.

In view of the above, the present invention aims to provide a solution that helps overcome the above discussed drawbacks and shortcomings of the prior art.

### SUMMARY OF THE INVENTION

The primary objective of the present invention is to provide a temperature homogenization and protection structure of a barbecue grill, in which a grate is provided with a temperature homogenization protection zone and a temperature homogenization zone and a burner is provided with a protector board arranged above the burner so that the structure, as a whole, helps better homogenize a grilling temperature and also prevents grease/fat, juice, and sauce from dropping from grilled food onto the burner.

To achieve the above objective, the present invention is provided for being applicable to a barbecue grill. The present invention comprises at least one burner and at least one grate, wherein the burner is arranged in a barbecue grill is provided, on a top side thereof, with a protector board, which comprises a plurality of through openings formed therein; and the grate is arranged in a top opening of the barbecue grill and comprises a plurality of ribs, such that a plurality of openings are formed among the ribs, and the ribs are provided with at least one temperature homogenization protection section corresponding to the burner and the protector board and at least one temperature homogenization section.

As such, the temperature homogenization protection section, the temperature homogenization section, and the protector board are provided to help homogenize the grilling temperature and protect the burner.

Beneficial efficacies of the present invention are as follows:

(1) The temperature homogenization protection sections provide temperature homogenization protection zones in the centers of the grates to help homogenize the grilling temperature and prevent liquids, such as grease/fat of food being grilled, juice of meat, and sauce from dropping down onto the protector board and the burners to potentially catch a fire or generate smoke and in addition, the temperature homogenization sections provide temperature homogenization zones in side portions of the grates so as to further help homogenize the grilling temperature.

(2) The protector boards help conduct and uniformly distribute the high temperature generated by the burners and effectively prevents liquids, such as grease/fat of food being grilled, juice of meat, and sauce, generated on the top side from falling onto the burners; while radiation thermal energy emitting from the burners is allowed to transmit through the through openings to directly apply to the grates, making better performance of grilling.

(3) Burners of high performance, such as those commercially available from Sabaf S.p.A., Italy, can be used in the present invention to further improve performance of grilling

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view of the present invention.

FIG. 2 is a perspective view showing a small grate, a burner, and a protector board of the present invention.

FIG. 3 is a cross-sectional view showing an example demonstrating a use of the present invention.

FIG. 4 is a perspective view showing a large grate of the present invention.

FIG. 5 is a perspective view showing the large grate of the present invention in a condition of being turned over to show a bottom thereof.

FIG. 6 is a perspective view showing the small grate of the present invention.

FIG. 7 is a perspective view showing the small grate of the present invention in a condition of being turned over to show a bottom thereof.

FIG. 8 is a top plan view showing the large grate and small grates used in combination by being jointed side by side as an example demonstrating a use thereof.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

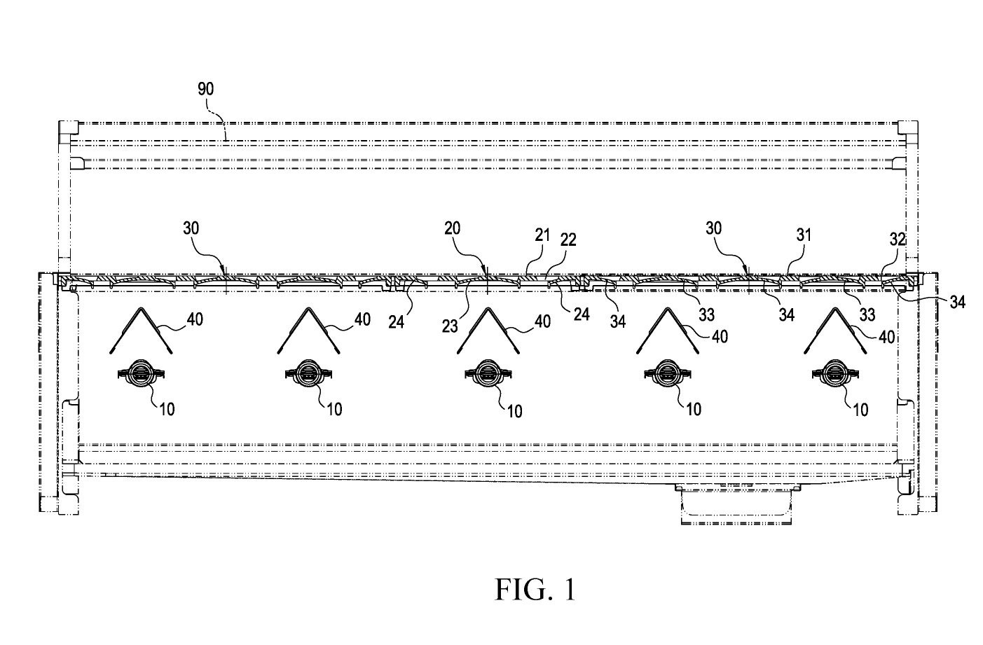

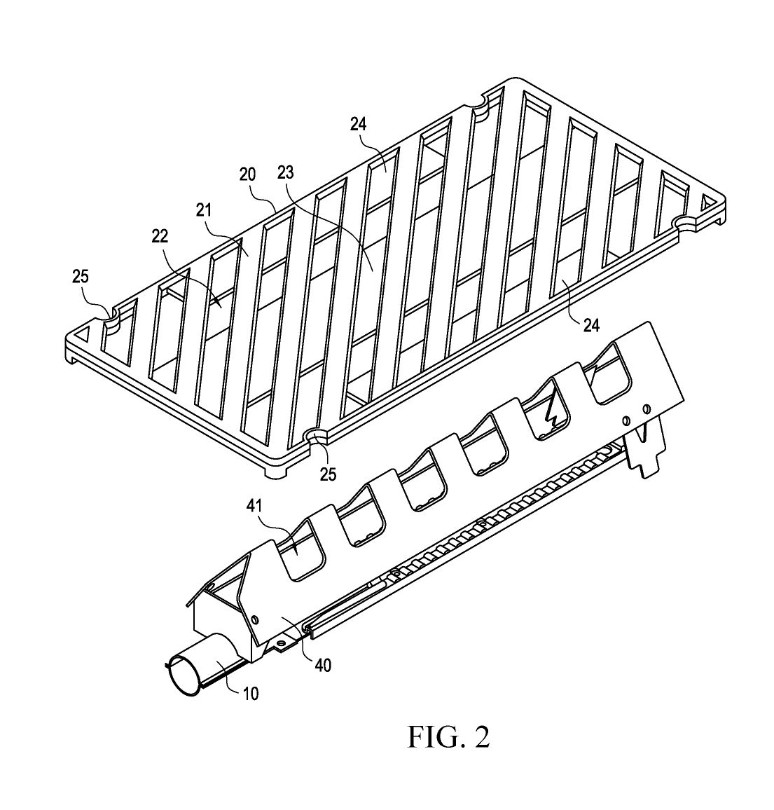

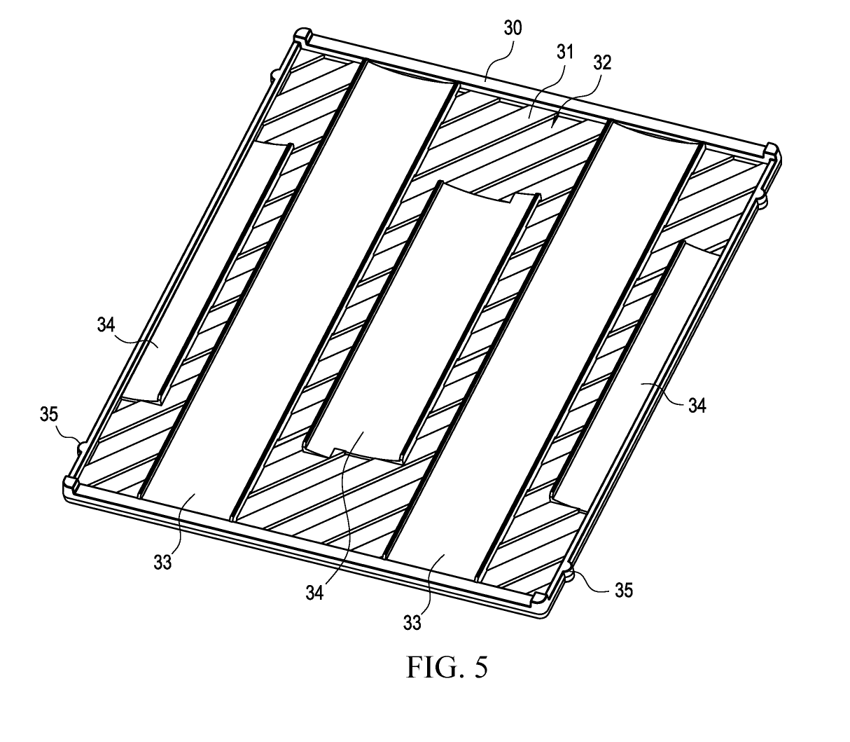

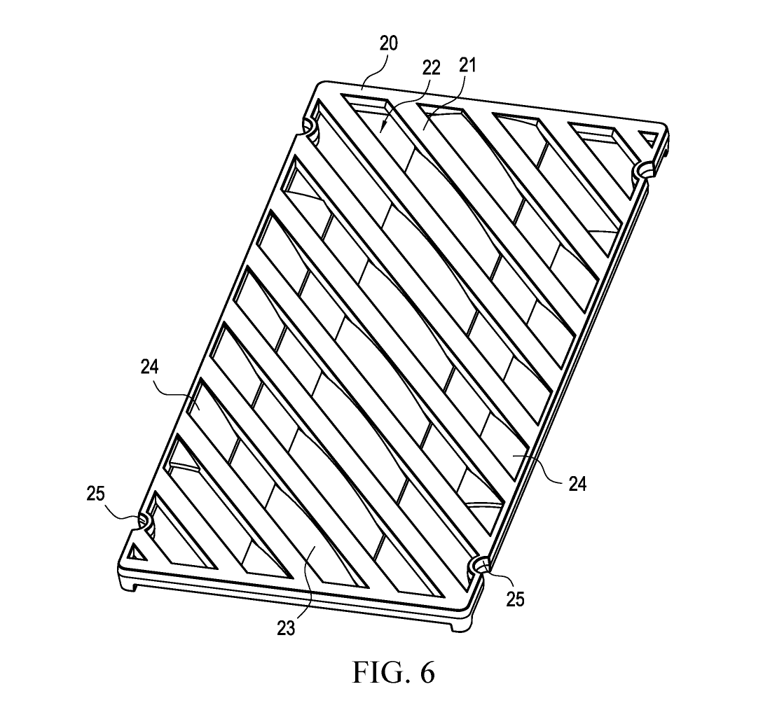

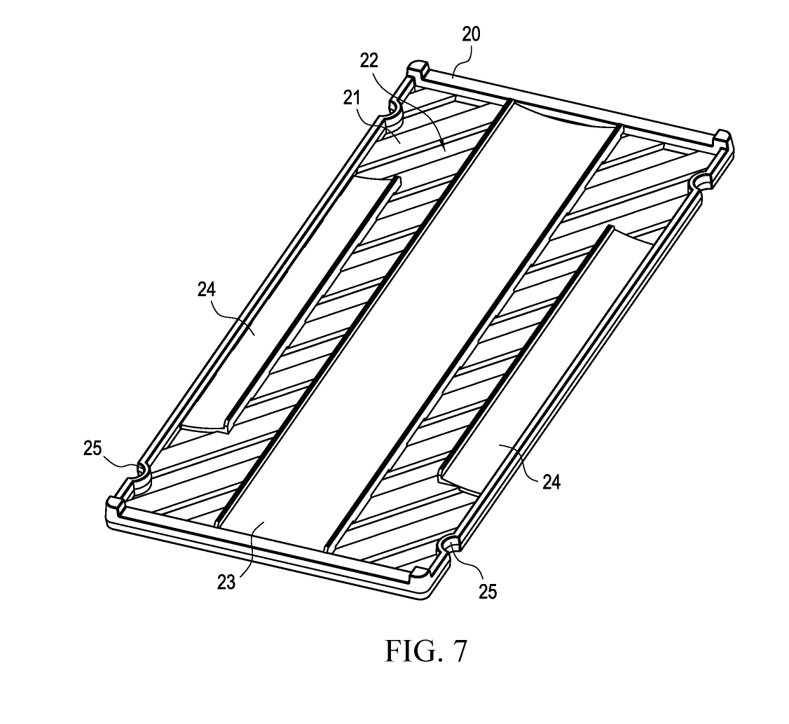

Referring to FIGS. 1, 2, 3, 4, 5, 6, and 7, the present invention is applicable to a barbecue grill 90, and a preferred embodiment of the present invention comprises a plurality of burners 10 and a plurality of grates 20, 30. Details will be provided below:

The burners 10 are arranged in the barbecue grill 90 and the burners 10 are each provided with a protector board 40 arranged on a top side thereof The protector board 40 comprises a plurality of through openings 41.

The grates 20, 30 are arranged in a top opening of the barbecue grill 90. In the instant embodiment, only one grate 20 is provided and is arranged at a middle portion, and two grates 30 are provided and are respectively arranged adjacent to two opposite sides of the grate 20. The grate 20, 30 each comprise a plurality of ribs 21, 31 and the ribs 21, 31 respectively define therebetween a plurality of openings 22, 33. The ribs 21 of the grate 20 are provided with a temperature homogenization protection section 23 and two temperature homogenization sections 24; and the ribs 31 of each of the grates 30 are provided with two temperature homogenization protection sections 33 and three temperature homogenization sections 34. The temperature homogenization protection sections 23, 33 are arranged to correspond to the burners 10 and the protector boards 40 associated therewith.

In an embodiment, the grate 20 is of a small size, while the grates 30 are of a large size.

In an embodiment, the temperature homogenization protection section 23 of the grate 20 is set at a location that is generally in a central zone of the grate and the temperature homogenization sections 24 of the grate 20 are respectively set at locations in two side zones of the grate 20.

In an embodiment, the temperature homogenization protection sections 33 and the temperature homogenization sections 34 of the grates 30 are arranged alternate with each other.

In an embodiment, the temperature homogenization protection sections 23, 33 and the temperature homogenization sections 24, 34 of the grates 20, 30 are arranged at a bottom side of the ribs 21, 31 such that a bottom surface of each of the temperature homogenization protection sections 23, 33 and the temperature homogenization sections 24, 34 may receive, in the entirety thereof, radiation energy emitting from the burners 10 to enhance performance of homogenization of grilling temperature.

In an embodiment, the protector boards 40 each have a cross-sectional configuration that is an inverted V-shape.

In an embodiment, the burners 10 are burners that are commercially available from Sabaf S.p.A., Italy.

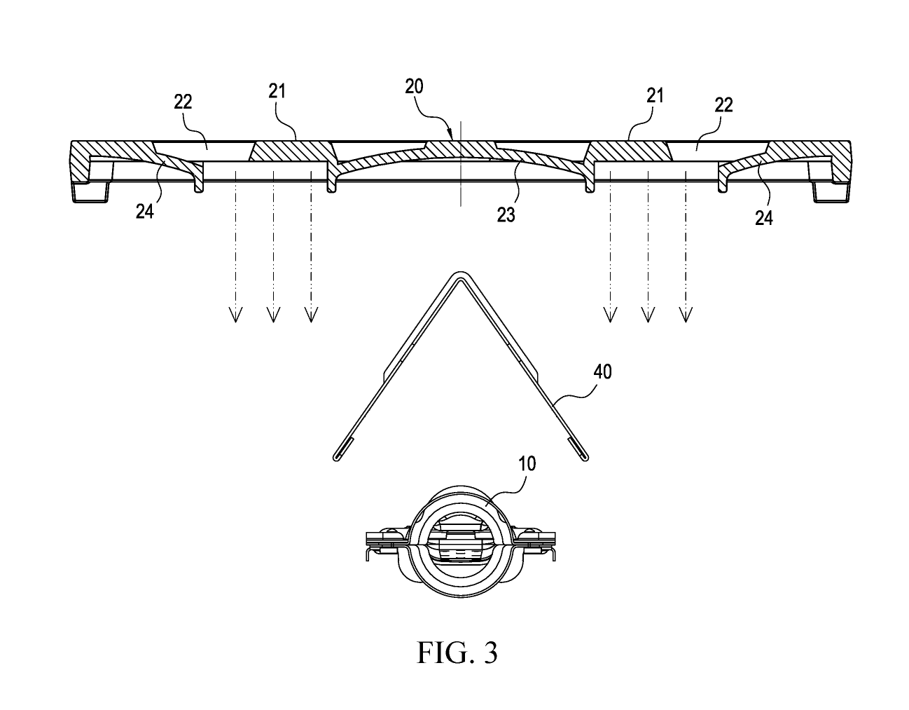

Referring to FIGS. 1 and 3, in an embodiment, the temperature homogenization protection section 23 and the temperature homogenization sections 24 of the grate 20 are each configured with a top surface that is curved, in an upward convex form, to facilitate guide grease of grilled food to flow toward two opposite sides of the temperature homogenization protection section 23 and the temperature homogenization sections 24.

Also, the temperature homogenization protection sections 33 and the temperature homogenization sections 34 of the grates 30 are each similarly configured with a top surface that is curved, in an upward convex form, to provide the same effect as that of the grate 20.

The temperature homogenization protection section 23 and the temperature homogenization sections 24 of the grate 20 are each provided, on two opposite side edges thereof, with ribs that extends downward therefrom to guide the grease of the grilled food to flow downward along the ribs to drop down therefrom so as to prevent the grease of the grilled food from flowing to bottoms of the temperature homogenization protection section 23 and the temperature homogenization sections 24 and dropping from the bottoms directly down onto the protector boards 40 or the burners 10.

The temperature homogenization protection sections 33 and the temperature homogenization sections 34 of the grates 30 are each similarly provided, on two opposite side edges thereof, with ribs that extends downward therefrom to provide the same function as those counterparts of the grate 20.

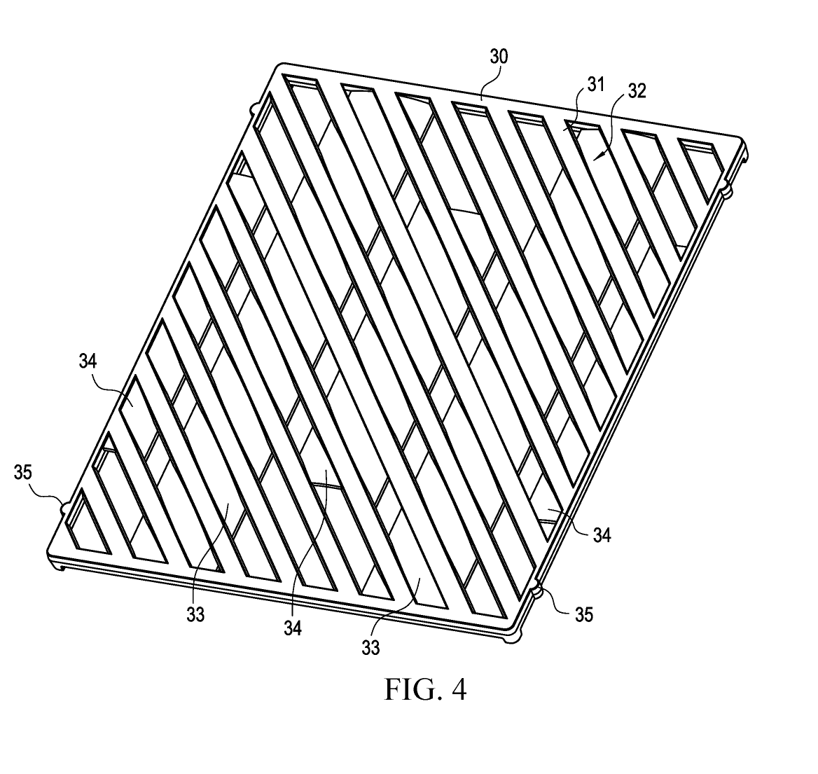

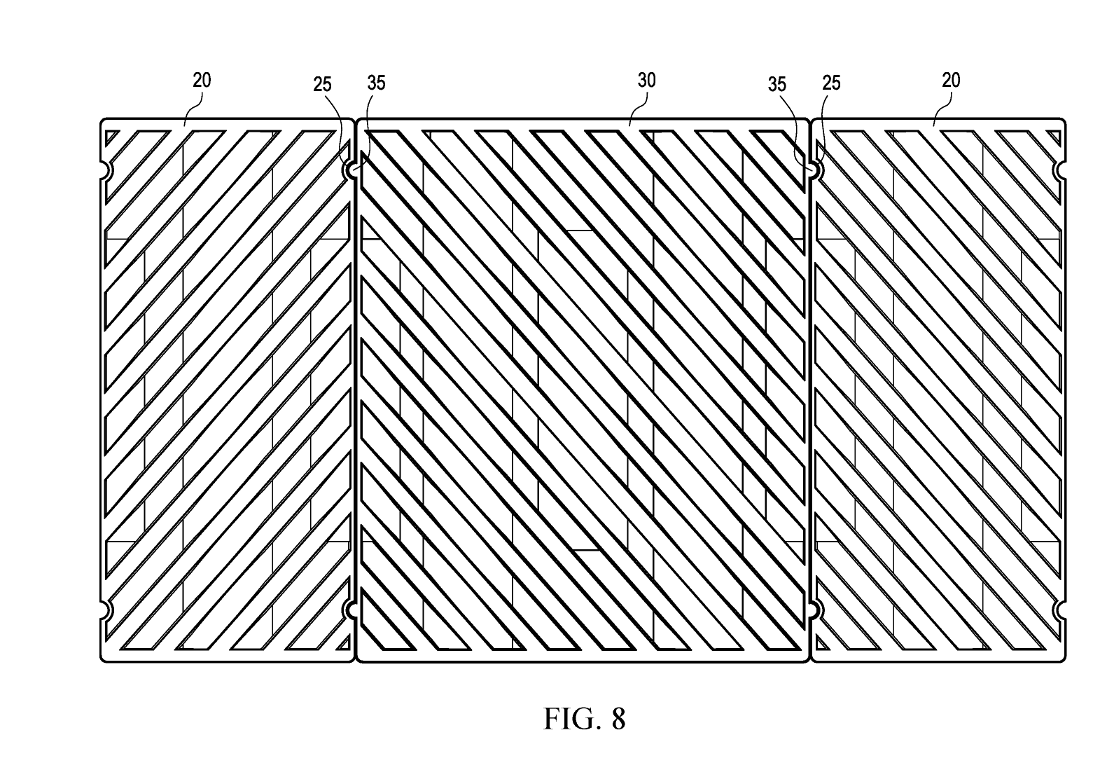

Referring to FIGS. 4, 5, 6, 7 and 8, in an embodiment, the grate 20 is provided, on each of two sides thereof, with a plurality of recesses 25; and the grates 30 are each provided, on each of two sides thereof or on at least one of the two sides thereof, with a plurality of projections 35, where the recesses 25 and the projections 35 correspond in position to each other such that the recesses 25 and the projections 35 that are provided on sides of the grates 20, 30 that are put adjacent to each other are allow to mate, engage, and thus interconnect with each other.

As such, the grates 20, 30 are connectable to each other with stability such that relative positions thereof are securely fixed and movement is generally prevented.

The above provides a description to the components/parts of the present invention, as well as assembly thereof, and an example of use, features, and advantages of the present invention will be provided below.

Referring to FIGS. 1, 2, 3, and 4, the present invention is structured such that the temperature homogenization protection sections 23, 33, the temperature homogenization sections 24, 34 and the protector board 40 are provided to help homogenize the grilling temperature and also to protect the burners 10.

Beneficial efficacies of the present invention are as follows:

(1) The temperature homogenization protection sections 23, 33 provide temperature homogenization protection zones in the grates 20, 30 to help homogenize the grilling temperature and prevent liquids, such as grease/fat of food being grilled, juice of meat, and sauce (as indicted by phantom lines of FIG. 3) from dropping down onto the protector board 40 and the burners 10 to potentially catch a fire or generate smoke and in addition, the temperature homogenization sections 24, 34 provide temperature homogenization zones in the grates 20, 30 so as to further help homogenize the grilling temperature.

(2) The protector boards 40 help conduct and uniformly distribute the high temperature generated by the burners 10 and effectively prevents liquids, such as grease/fat of food being grilled, juice of meat, and sauce, generated on the top side from falling onto the burners 10; while radiation thermal energy emitting from the burners 10 is allowed to transmit through the through openings 41 to directly apply to the grates 20, 30, making better performance of grilling.

(3) Burners of high performance, such as those commercially available from Sabaf S.p.A., Italy, can be used in the present invention to further improve performance of grilling

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A temperature homogenization and protection structure of a barbecue grill, comprising:
at least one burner, which is arranged in a barbecue grill, the burner being provided, on a top side thereof, with a protector board, which comprises a plurality of through openings formed therein; and
at least one grate, which is arranged in a top opening of the barbecue grill, the grate comprising a plurality of ribs, such that a plurality of openings are formed among the ribs, the ribs being provided with at least one temperature homogenization protection section and at least one temperature homogenization section, the temperature homogenization protection section corresponding to the burner and the protector board.

2. The temperature homogenization and protection structure of the barbecue grill according to claim 1, wherein the at least one grate comprises a plurality of grates, of which some are grates of a relatively small size, while the remaining ones are grates of a relatively large size.

3. The temperature homogenization and protection structure of the barbecue grill according to claim 1, wherein the temperature homogenization protection section of the grate is arranged in a central zone of the grate and the temperature homogenization section of the grate are arranged in two side zones of the grate.

4. The temperature homogenization and protection structure of the barbecue grill according to claim 1, wherein the temperature homogenization protection section and the temperature homogenization section of the grate are arranged alternate with each other.

5. The temperature homogenization and protection structure of the barbecue grill according to claim 1, wherein the temperature homogenization protection section and the temperature homogenization sections the grate are arranged on a bottom of the ribs.

6. The temperature homogenization and protection structure of the barbecue grill according to claim 1, wherein the protector board has an inverted V-shape.

7. The temperature homogenization and protection structure of the barbecue grill according to claim 1, wherein the at least one grate comprises a plurality of grates that are arranged adjacent to each other in a side by side manner, one of the grates having two opposite sides that are provided with a plurality of recesses, another one of the grates having two sides that are provided with a plurality of projections, the recesses and the projections corresponding to each other in position such that the recesses and the projections of the two grates that are set adjacent to each other are engageable with each other to achieve connection between the grates.

8. The temperature homogenization and protection structure of the barbecue grill according to claim 1, wherein the temperature homogenization protection section and the temperature homogenization section of the grate have a top surface that is curved.

9. The temperature homogenization and protection structure of the barbecue grill according to claim 1, wherein the temperature homogenization protection section and the temperature homogenization section of the grate each have two opposite side edges each comprising a rib extending downward therefrom.
